(19) United States
(12) Patent Application Publication
(10) Pub. No.: US 2015/0060219 A1
(43) Pub. Date: Mar. 5, 2015

(54) HYDRODYNAMIC RETARDER

(71) Applicant: ZF Friedrichshafen AG, Friedrichshafen (DE)

(72) Inventor: Bernd WOLFLE, Meckenbeuren (DE)

(21) Appl. No.: 14/315,622

(22) Filed: Jun. 26, 2014

(30) Foreign Application Priority Data
Sep. 3, 2013 (DE) 10 2013 217 551.5

(51) Int. Cl. F16D 57/04

(52) U.S. Cl. CPC F16D 57/04
USPC 188/296

(57) ABSTRACT

A hydrodynamic retarder having a rotor (2) and a stator (1). The rotor (2) and the stator (1) are arranged radially relative to one another. An interruption mechanism is provided for interrupting the fluid coupling between the rotor (2) and the stator (1).

This application claims priority from German patent application serial no. 10 2013 217 551.5 filed Sep. 3, 2013.

### FIELD OF THE INVENTION

The invention concerns a hydrodynamic retarder, comprising a rotor and a stator. Furthermore, the invention concerns a drive-train of a motor vehicle having a hydrodynamic retarder of the above type.

### BACKGROUND OF THE INVENTION

Hydrodynamic retarders are used, in particular, in commercial vehicles as wear-free permanent brakes. To produce a braking torque they use the flow energy of a liquid held in a toroidal space between a stator and a rotor. Inside the toroidal space the spinning rotor picks up the liquid by means of its blades, and the liquid then impinges on the blades of the stator, thereafter returning back again to the rotor blades. By virtue of this a braking torque is exerted on the rotor, the size of this braking torque usually being governed by the quantity of liquid present in the toroidal space. However, even when a hydrodynamic retarder is operating while empty, i.e. when the toroidal space is not filled, a certain braking torque is produced by it which is caused by forced air circulation between the rotor and the stator. To avoid these power losses, also referred to as air losses, annular and diaphragm dampers are often provided, which can swivel between the rotor and stator so that the air circulation is reduced.

DE 10 2007 032 935 A1 describes a hydrodynamic retarder with a rotor and a stator arranged axially opposite one another. Moreover, both the rotor and the stator are fitted with blades such that to produce a braking torque on the rotor, the rotor and stator can be coupled hydraulically with one another by a liquid which, for that purpose, is contained in a toroidal space formed between the rotor and the stator. In this case, the quantity of liquid introduced is regulated as a function of a braking torque to be produced at the time, and other than for a braking operation the liquid is drained completely out of the toroidal space. To avoid air losses between the rotor and stator during such operation while empty, baffle-plates are provided, each of which can be pushed radially into the toroidal space by a respective associated piston, thereby reducing the air circulation between the rotor and the stator.

### SUMMARY OF THE INVENTION

Starting from the above prior art, the purpose of the present invention is now to provide a hydrodynamic retarder in which air losses are reduced as much as possible, with little cost and complexity.

This objective is achieved with the characterizing features specified below,

According to the invention, a hydrodynamic retarder comprises a rotor and a stator. In a manner whose principle is understood by those with knowledge of the field, braking torque can be exerted on the rotor since both the rotor and the stator are fitted with blades and can be hydraulically coupled with one another by the flow of a fluid between the blades. The way this happens is that the fluid is propelled by the blades of the rotor and then impinges on the static blades of the stator, off which it bounces back to the rotor blades. The returning fluid then acts to slow down the rotor.

In a drive-train of a motor vehicle the hydrodynamic retarder can be arranged either as a primary retarder between a drive engine and a motor vehicle transmission, or it can be connected downstream from the motor vehicle transmission as a secondary retarder. Particularly in the case of a secondary retarder, the retarder can be connected if necessary by way of a high-driver stage. Furthermore, the retarder can be integrated in the motor vehicle transmission or it can be an assembly separate therefrom.

The invention now adopts the technical feature that the rotor and stator are arranged radially relative to one another. In other words, the rotor and stator are positioned radially opposite one another, either with the rotor radially inside the stator or with the stator radially inside the rotor. Consequently, in each case the blades of the rotor and stator are also directed radially.

Such a hydrodynamic retarder design has the advantage that with this arrangement of the rotor and stator, measures to minimize air losses car, be implemented with little cost and complexity. Thus, with the radial configuration according to the invention a flow connection between the blades of the rotor and stator can be interrupted in a simple manner since the means that bring about the interruption can have a constant diameter during it. For example, in principle the extent of the interruption can be chosen freely. Moreover, if necessary an axially space-saving arrangement of the hydrodynamic retarder is possible if the rotor and stator are arranged radially to form an internal component of the motor vehicle transmission or of some other part of the drive-train.

In contrast, the baffle-plates of the hydrodynamic retarder described in DE 10 2007 032 935 A1 are of complex design and can only to a certain extent interrupt the flow connection between the blades of the rotor and stator.

In an embodiment of the invention, the rotor and stator are fitted with blades and means are provided by which a fluidic coupling between the blades can be interrupted. In this context “fluidic coupling” is understood to mean the coupling of the rotor and stator blades by way of a fluid, wherein rotary movement of the rotor blades picks up fluid, which is then accelerated in the direction toward the stator blades, from which it returns again toward the rotor blades. When the retarder is full, the fluid is a liquid, in particular oil or water, whereas in the sometimes empty condition of the retarder the fluid is air.

According to a first further development of this embodiment, the means consist in that the rotor and stator can move axially relative to one another. In other words, in this case the flow of fluid between the rotor and stator can be influenced by axial displacement of the rotor and stator relative to one another. In this way, during operation of the retarder when it is empty air turbulence and hence air losses can be reduced since the rotor and stator blades are positioned with the minimum possible axial overlap. For this, it is in principle conceivable that either the rotor or the stator, or even both components are designed to be able to move axially.

In an alternative design of the invention, the means are in the form of at least one axially movable sleeve that can be inserted radially between the retarder blades.

This too can substantially reduce air turbulence during operation of the retarder when it is empty, since a flow connection between the blades is interrupted by the at least one sleeve inserted between them. In this case the sleeve is preferably made with a hollow-cylindrical section or entirely as a hollow cylinder, and is introduced with that section or its entire body radially between the rotor and the stator. Consequently, an all-round interruption of the fluidic coupling can be achieved with little complexity. It is also conceivable, however, to provide a plurality of sleeves for the purpose.

In a further development of the above design, the at least one sleeve is coupled to the rotor or to the stator in a rotationally fixed manner. In this case, however, it is particularly preferable to couple the sleeve to the rotor, so that air moved by the rotor blades during empty operation does not impinge on a static sleeve, but on one that moves in unison with the rotor.

A further design feature of the invention is that the at least one sleeve can be moved axially by an actuator and in opposition to at least one spring element. The actuator can be an electrical actuator, for example a magnet or an electric motor, a hydraulic actuator, for example a hydraulically actuated piston, or a pneumatic actuator such as a pneumatically actuated piston. The at least one spring element presses the sleeve either in the direction of an initial, normal position in which the at least one sleeve does not extend between the rotor and stator, or toward a position where the sleeve extends completely between the rotor and stator, so that by means of the actuator a movement of the at least one sleeve in opposition to the pre-stressing of the spring element takes place. Depending on whether the sleeve is fixed on the rotor or the stator, the at least one spring element can be supported at its end against the rotor or the stator.

In another advantageous embodiment of the invention, the fluidic coupling can be eliminated completely by the means. In this way air losses during operation of the retarder while empty can be avoided entirely since no air can circulate between the rotor and stator. Moreover the retarder system as a whole can be simplified, since the fluid that produces a hydraulic coupling between the rotor and stator can be left in place and, other than during braking operation, the production of a braking torque is suppressed by the complete separation described above. Consequently, it is no longer necessary to fill and empty the toroidal space of the hydrodynamic retarder.

In a further development of the above embodiment and when the rotor and stator are designed to move axially relative to one another, a quantity of fluid is held permanently between the rotor and the stator, so that a braking torque acting on the rotor can be adjusted by the axial positioning of the rotor and stator relative to one another. In this case, therefore, the torque that can be produced by the retarder is controlled not by regulating the quantity of fluid, but by adjusting the axial overlap of the rotor blades and stator blades. Consequently there is no longer any need for the correspondingly complex hydraulic control system, which otherwise has to be provided for regulating the quantity of fluid.

Likewise also in the case when the means are in the form of at least one movable sleeve, a quantity of fluid can be held permanently in the toroidal space so that a braking torque acting on the rotor can be determined by the extent to which the at least one sleeve is introduced axially into the toroidal space. Thus, in this case the braking torque required is produced by positioning the at least one sleeve appropriately between the blades. Accordingly, again there is no need for a complex hydraulic system to regulate the quantity of fluid introduced into the toroidal space.

The invention is not limited to the combinations of characteristics indicated in the principal claim or in the claims that depend on it. Other possibilities exist for combining with one another individual features, insofar as they emerge from the claims, the description of preferred embodiments given below, or directly from the drawings. The reference of the claims to the drawings by the use of indexes is not intended to restrict the protective scope of the claims.

### BRIEF DESCRIPTION OF THE DRAWINGS

Advantageous design features of the invention, which are explained below, are represented in the drawings, which show:

FIG. 1: A schematic representation of a hydrodynamic retarder that corresponds to a first embodiment of the invention, shown in a first condition;

FIG. 2: Another schematic representation of the retarder in FIG. 1, shown in a second condition; and

FIG. 3: A schematic representation of a hydrodynamic retarder according to a second possible embodiment of the invention.

### DETAILED DESCRIPTION OF THE PREFERRED EMBODIMENTS

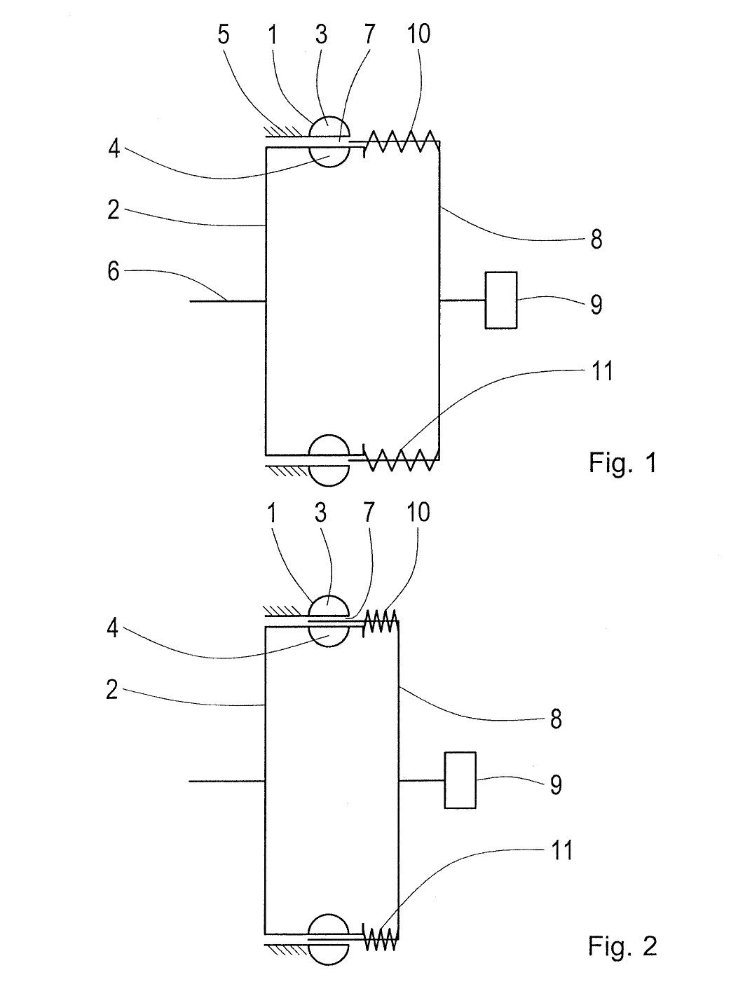

FIG. 1 shows a schematic representation of a hydrodynamic retarder which can be used in a drive-train of a motor vehicle, in particular a commercial vehicle. The retarder comprises a stator 1 and a rotor 2, each fitted with respective blades 3 and 4. As can also be seen, the stator 1 and so too therefore its blades 3 are attached fixed to a housing 5 of the retarder, whereas the rotor 2 is mounted to rotate on a rotor shaft 6.

As a special feature the rotor 2 and the stator 1 are arranged radially relative to one another, with the rotor 2 running radially inside the stator 1. Thus, the blades 3 and 4 too are radially opposite one another with the blades 3 of the stator 1 directed radially inward while, in contrast, the blades 4 of the rotor 2 extend radially outward. In a manner whose principle is known to those familiar with the field, a braking torque is produced on the rotor 2 and hence on the rotor shaft 6 when a fluid present in a toroidal space 7 formed between the blades 3 and 4 is picked up by the blades 4 of the rotor 2 and propelled toward the blades 3 of the stator 1. The fluid then bounces off the blades 3 and returns to the blades 4 of the rotor 2, and this exerts a torque on the rotor 2 whose effect is to slow it down.

In this case the fluid, for example oil or even water, is held permanently in the toroidal space 7 so that the braking torque acting on the rotor 2 is regulated by means of an axially movable sleeve 8 of hollow-cylindrical design which rotates together with the rotor 2. The sleeve 8 can be pushed by an actuator 9 against spring elements 10 and 11, axially into the toroidal space 7 and radially between the blades 3 and 4. Thus, by means of the actuator 9, which in the present case is in the form of a hydraulically actuated piston, in addition to a fully inserted position shown in FIG. 2 and a basic, initial position shown in FIG. 1 the sleeve can be moved to any intermediate position.

Thus, when it leaves the basic initial position the sleeve 8 interrupts the flow connection between the blades 3 and 4 so that as the axial displacement of the sleeve 8 increases, the braking torque acting on the rotor shaft 6 decreases. When the sleeve 8 finally reaches the end position shown in FIG. 2, in which it has moved axially all the way into the toroidal space 7, the blades 3 and 4 are completely separated from one another so that no braking torque can any longer act on the rotor 2.

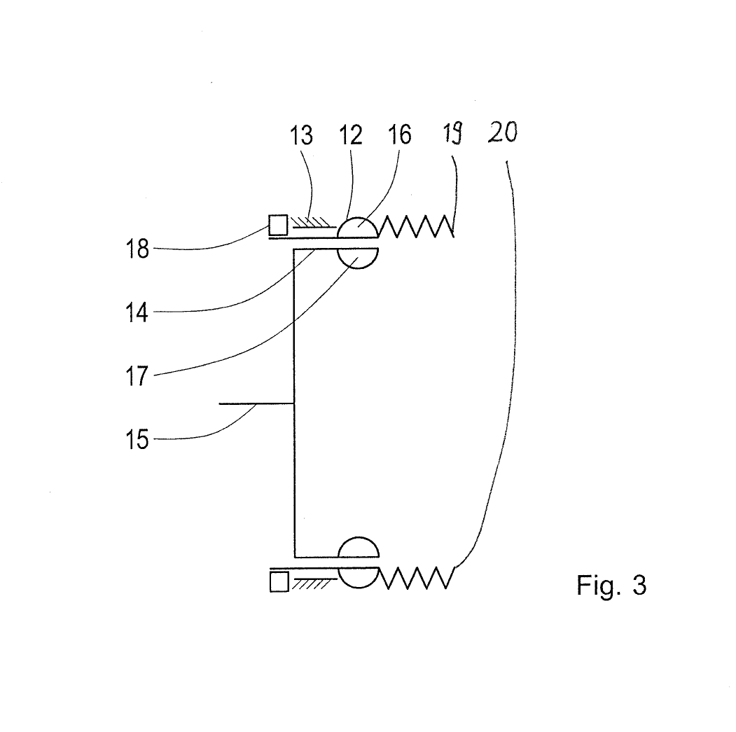

Finally, FIG. 3 shows a schematic representation of an alternative embodiment of a hydrodynamic retarder. The difference from the variant described above is that in this case, although a stator 12 is again coupled to a housing 13 in a rotationally fixed manner, it can be moved axially relative thereto, The housing 13 and the stator 12 can be connected, for example, by a splined shaft. Again, a rotor 14 on a rotor shaft 15 runs radially inside the stator 12. In addition, as in the previous variant a fixed quantity of fluid is held between the stator 12 and the rotor 14, but with the difference from the variant described previously that the braking torque is this time adjusted by moving the stator 12 axially relative to the rotor 14 so that the blades 16 of the stator 12 also move axially relative to the blades 17 of the rotor 14.

In the position shown in FIG. 3, the blades 16 and 17 completely axially overlap, so that the fluid picked up by the blades 17 is all propelled onto the blades 16, thereby producing the maximum braking torque on the rotor 14. On the other hand, if the stator 12 is moved to an end position—not shown here—in which the blades 16 no longer overlap at all with the blades 17, then the fluid picked up by the blades 17 is no longer directed onto the blades 16 of the stator 12 and accordingly no braking torque is any longer exerted on the rotor 14. Again, the braking torque can be varied as desired by adopting positions intermediate between the two extreme positions described above. In this case the appropriate axial position of the stator 12 is set in opposition to spring elements 19 and 20 by means of an actuator 18, in the present case designed as an electromagnetic actuator.

In a suitable arrangement (not shown here) it is also possible for the rotor to be displaced axially relative to the positionally fixed stator.

By virtue of the design of a hydrodynamic retarder in accordance with the invention, air losses of a retarder can be reduced very substantially in a simple manner.

### INDEXES

1 Stator

2 Rotor

3 Blades

4 Blades

5 Housing

6 Rotor shaft

7 Toroidal space

8 Sleeve

9 Actuator

10 Spring element

11 Spring element

12 Stator

13 Housing

14 Rotor

15 Rotor shaft

16 Blades

17 Blades

18 Actuator

19 Spring element

20 Spring element

1-10. (canceled)

11. A hydrodynamic retarder comprising:
a rotor (2; 14), and
a stator (1; 12),
wherein the rotor (2; 14) and the stator (1; 12) are arranged radially relative to one another.

12. The hydrodynamic retarder according to claim 11, wherein the rotor (2; 14) is fitted with blades (3, 4; 16, 17) and the stator (1; 12) is fitted with blades (3, 4; 16, 17), and
means are provided by which a fluidic coupling between the blades (3, 4; 16, 17) of the rotor (2; 14) and the stator (1; 12) is interruptible.

13. The hydrodynamic retarder according to claim 12, wherein the means comprises axial mobility of the rotor (14) and the stator (12) relative to one another.

14. The hydrodynamic retarder according to claim 12, wherein the means being at least one axially movable sleeve (8) which is insertable into a toroidal space formed between the rotor (2) and the stator (1).

15. The hydrodynamic retarder according to claim 14, wherein the at least one sleeve (8) is coupled, in a rotationally fixed manner, to either the rotor or the stator.

16. The hydrodynamic retarder according to claim 14, wherein the at least one sleeve (8) is axially movable by an actuator (9) in opposition to at least one spring element (10, 11).

17. The hydrodynamic retarder according to claim 12, wherein the fluidic coupling is completely eliminated during relative rotation of the rotor (2; 14) and the stator (1; 12).

18. The hydrodynamic retarder according to claim 13, wherein a quantity of fluid is permanently retained between the rotor (14) and the stator (12), and
a braking torque acting on the rotor (12) is adjustable by axially positioning of the rotor (14) and the stator (12) relative to one another.

19. The hydrodynamic retarder according to claim 14, wherein a quantity of fluid is permanently retained in the toroidal space (7), and
a braking torque, acting on the rotor (2), is determined by an extent to which the at least one axially movable sleeve (8) is inserted into the toroidal space.

20. A hydrodynamic retarder in combination with a drive-train of a motor vehicle, the hydrodynamic retarder comprising:
a rotor (2; 14), and
a stator (1; 12),
wherein the rotor (2; 14) and the stator (1; 12) are arranged radially relative to one another.

21. A hydrodynamic retarder comprising:
a rotor,
a stator,
the rotor and the stator being radially aligned with respect to one another with one of the rotor and the stator being arranged radially within the other one of the rotor and the stator; and
a movable sleeve being insertable into a toroidal space, located between the rotor and the stator, for interrupting fluidic coupling between the rotor and the stator.

22. The hydrodynamic retarder according to claim 21, wherein each of the rotor and the stator comprises a plurality of blades, the blades of the rotor are radially aligned with the blades of the stator, and the blades of the rotor are radially separated from the blades of the stator by the toroidal space which contains fluid that facilitates the fluidic coupling of the blades so that a rotational force of one of the rotor and the stator exerts a rotational force on the other one of the rotor and the stator.

23. The hydrodynamic retarder according to claim 22, wherein an actuator is connected to the sleeve, the actuator biases the sleeve between at least first and second axial positions, the sleeve in the first axial position is axially spaced from the toroidal space to permit the fluidic coupling between the blades, and the sleeve, in the second axial position, is located in the toroidal space between the blades of the rotor and the blades of the stator and at least partially interrupts the fluidic coupling between the blades.

24. The hydrodynamic retarder according to claim 23, wherein the sleeve abuts against at least one spring which bias the sleeve axially in a direction which permits the fluidic coupling between the blades.
